(19) United States
(12) Patent Application Publication
(10) Pub. No.: US 2010/0268839 A1
(43) Pub. Date: Oct. 21, 2010

(54) METHOD AND APPARATUS FOR PROVIDING AN AUDIOVISUAL STREAM

(75) Inventors: Alexis Olivereau, Orsay (FR); David Bonnefoy-Cudraz, Gilly sur Isere (FR); Christophe Janneteau, Chaudon (FR); Jerome Picalt, Massy (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/743,874

(22) PCT Filed: Nov. 3, 2008
(86) PCT No.: PCT/US08/82212

§ 371 Date: May 20, 2010

(30) Foreign Application Priority Data
Dec. 11, 2007 (GB) 0724170.6

(51) Int. Cl. G06F 15/16

(52) U.S. Cl. 709/231

(57) ABSTRACT

An audio stream server (115) comprises a request processor (203) which receives an audiovisual stream request for an audiovisual stream from a communication unit (101). The request comprises a location indication for the audiovisual stream. A selection processor (205) selects a group of stream feed units (103) from a plurality of stream feed units in response to the location indication and a stream data processor (207) receives audiovisual streams from at least one stream feed unit of the group of stream feed units (103). A stream generation processor (209) then generates an audiovisual stream for the communication unit (101) from the received audiovisual stream and a stream transmit processor (211) transmits the generated audiovisual stream to the communication unit (101). The communication unit (101) and/or the stream feed units (103) may specifically be user equipments of a cellular communication system. The invention may allow an audio stream for a given real world location to be provided on request e.g. using an existing cellular communication system.

### FIELD OF THE INVENTION

The invention relates to a method and apparatus for providing an audiovisual stream and in particular, but not exclusively, to providing an audio stream using a cellular communication system.

### BACKGROUND OF THE INVENTION

In recent years, technological advances have provided many new user experiences and entertainment services. In particular, developments in computing and communication have lead to many new experiences for example based on ubiquitous coverage provided by mobile communications or the Internet.

For example, virtual experiences and worlds have been developed wherein users can participate in an artificial and emerging experience. Current trends in modelling of virtual worlds can roughly be categorized into two categories. For the first category, pure virtual worlds are created that e.g. serve as a basis for social networking applications or games. The other category seeks to merge the virtual aspect with a real world aspect to provide a more involving experience that is more closely linked to the real world.

For example, the real earth can be modelled more and more accurately thereby enabling a wide variety of applications, ranging e.g. from service localization to virtual tourism. For example, applications have been developed which based on satellite photographs provides a virtual travel experience where users can move and zoom in on different areas across the world.

However, currently such applications tend to be based on captured and stored data and do not include real time data. Consequently, the correlation between virtual experiences and real world experiences is limited and many users find this to be one of the most significant limitations of the experience. For example, a major limitation of the virtual Earth application based on satellite images is that these are limited to stored images that may be several years old and which therefore do not reflect current conditions.

However, providing real time data is very difficult and resource demanding. In particular, efficiently integrating real time data with virtual experiences is technically demanding and accordingly current experiences that provide such integration tends to be very limited and provide only a small amount of real time content. An example of such a system is flight simulators wherein the environment may be generated by combining pre-captured and stored environment data (such as the landscape) with real time data thereby allowing the player to experience virtual weather which is correlated with the real current weather in the corresponding real world location.

Thus, there is currently a strong desire to further provide or improve services based on real world, and preferably real time, data and in particular there is a strong desire to provide services that can enhance or improve virtual experiences by including real world, and preferably real time, data.

Hence, an improved system would be advantageous and in particular a system allowing increased flexibility, facilitated implementation, reduced cost, reduced resource usage, improved virtual experiences, improved real world (and/or real time) correlation and/or improved and/or new user services or experiences would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus comprising: means for receiving an audiovisual stream request for an audiovisual stream from a communication unit, the audiovisual stream request comprising a location indication for the audiovisual stream; selection means for selecting a group of stream feed units from a plurality of stream feed units in response to the location indication; means for receiving at least one received audiovisual stream from at least one stream feed unit of the group of stream feed units; generation means for generating a first audiovisual stream for the communication unit from the at least one received audiovisual stream; and means for transmitting the first audiovisual stream to the communication unit.

The invention may allow facilitated and/or reduced complexity and/or cost for providing audiovisual streams to a communication unit. The invention may enable and/or facilitate user services providing audiovisual streams.

The invention may allow a practical and/or efficient provision of audiovisual data reflecting conditions at a desired location.

For example, the communication unit may operate an application providing a virtual experience to a user. The user may be at a given location in the virtual world provided by the application and may request a real world audio stream from the corresponding location in the real world. The invention may provide such an audio stream thereby enhancing the user experience.

The invention may allow efficient and/or low complexity coordination between virtual world and real world data to be achieved. For example, the invention may relatively easily allow a virtual world application to be provided with corresponding real world data.

The first audiovisual data may for example be the received audiovisual data from a single stream feed unit and/or may be combined audiovisual data from a plurality of stream feed units.

The audiovisual stream may e.g. be audio data only or may be visual data only or may be combined audio and video data.

The received audiovisual stream(s) may be real world data captured by the stream feed units in response to receiving a request for an audiovisual stream. Specifically, the audiovisual stream(s) received from a stream feed unit may be real time audiovisual data captured by the stream feed unit. E.g. the data may include audio data currently recorded by a microphone and/or video or image data currently recorded by a camera. The audiovisual stream from a stream feed unit may specifically be (current) real time audiovisual environment data for the stream feed unit.

According to a feature of the invention, the stream feed units are user equipments of a cellular communication system.

The invention may allow an existing (almost ubiquitous) communication system to provide real word (possibly real time) audiovisual streams from a specified location to a communication unit e.g. operating a virtual world application.

For example, the invention may allow that a user experiencing a virtual location in a virtual application can be efficiently provided with real time ambient audio from the corresponding real world location.

According to another aspect of the invention, there is provided a communication system comprising a server, the server comprising: means for receiving an audiovisual stream request for an audiovisual stream from a communication unit, the audiovisual stream request comprising a location indication for the audiovisual stream; selection means for selecting a group of stream feed units from a plurality of stream feed units in response to the location indication; means for receiving at least one received audiovisual stream from at least one stream feed unit of the group of stream feed units; generation means for generating a first audiovisual stream for the communication unit from the at least one received audiovisual stream; and means for transmitting the first audiovisual stream to the communication unit.

According to another aspect of the invention, there is provided a method for providing an audiovisual stream comprising: receiving an audiovisual stream request for an audiovisual stream from a communication unit, the audiovisual stream request comprising a location indication for the audiovisual stream; selecting a group of stream feed units from a plurality of stream feed units in response to the location indication; receiving at least one received audiovisual stream from at least one stream feed unit of the group of stream feed units; generating a first audiovisual stream for the communication unit from the at least one received audiovisual stream; and transmitting the first audiovisual stream to the communication unit.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an example of an audio stream server in accordance with some embodiments of the invention; and

FIG. 3 illustrates an example of a flowchart of a method of providing an audio stream in accordance with some embodiments of the invention.

### DETAILED DESCRIPTION OF SOME EMBODIMENTS OF THE INVENTION

The following description focuses on embodiments of the invention applicable to a cellular communication system used to provide an audio stream. However, it will be appreciated that the invention is not limited to this application.

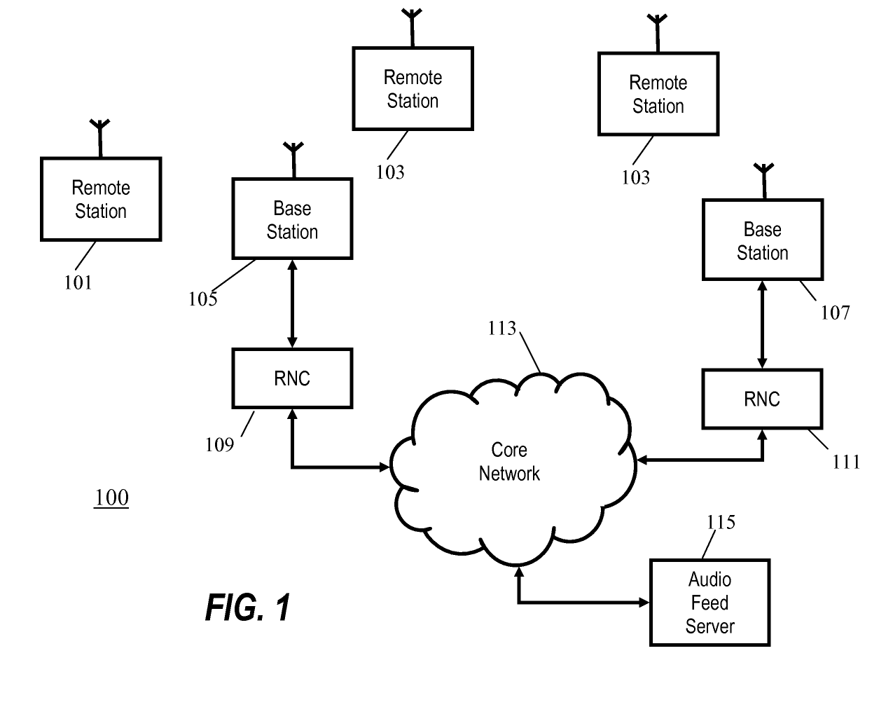

FIG. 1 illustrates an example of a cellular communication system in accordance with some embodiments of the invention.

The cellular communication system is specifically a GSM/UMTS cellular communication system which supports a plurality of user equipments. However, it will be appreciated that in other embodiments other cellular communication systems (such as e.g. a WiMAX™ system) or non-cellular communication systems may be used.

A user equipment may be any communication entity capable of communicating with a base station (or access point) over the air interface including e.g. a mobile phone, a mobile terminal, a mobile communication unit, a remote station, a mobile station, a subscriber unit, a 3G User Equipment etc.

In the example, three user equipments 101, 103 are illustrated. The user equipments 101, 103 are supported over the air interface by base stations 105, 107 which are coupled to respective Radio Network Controllers (RNCs) 109, 111 which perform routing, resource scheduling etc for the supported base stations 101, 103 as will be known to the person skilled in the art.

The RNCs 109, 111 are coupled to a central network 113 which represents all other aspects of the fixed segment of the GSM/UMTS communication system including other base stations, RNCs, Mobile Switching Centres etc as will be well known to the person skilled in the art.

The cellular communication system furthermore comprises an audio stream server 115 which is arranged to provide an ambient audio service to users. In the example, the audio stream server 115 is illustrated to be connected to the central network 113 but it will be appreciated that any suitable means allowing communication between the audio stream server 115 and the user equipments 101, 103 (or other audio stream feed units) may alternatively or additionally be used. For example, the audio stream server 115 may be coupled to the central network 113 via an external communication network such as the Internet. As another example, the Internet may be used for communication between the different functional units of the system, such as between the audio stream server 115 and the requesting communication unit and/or the audio stream feed units 101, 103. The Internet may be used in addition or as an alternative to the cellular communication system.

In the system, a first user equipment 101 can transmit an audio stream request to the audio stream server 115. The request includes an indication of a location from which an audio stream is requested. In response, the audio stream server 115 identifies one or more user equipments 103 which are at the specified location (or e.g. within a predetermined distance from the specified location) and requests that these user equipments 103 initiate a real time audio stream. Thus, the selected user equipments 103 can in response to the request start capturing audio at their current location and transmit the resulting audio stream data to the audio stream server 115. The audio stream server 115 then generates an audio stream for the requesting user equipment 101 (e.g. by selecting one received audio stream or by combining a plurality of received audio streams). The generated audio stream is then transmitted to the requesting user equipment 101. Thus, the audio stream server 115 can provide a desirable service wherein users of the cellular communication system can request an audio stream from any given location and in response can be provided with a real time real life audio from the specified location provided at least one suitable user equipment 103 is located close thereto.

The approach exploits existing communication system resource and functionality to provide an additional service and specifically to capture and provide real-time audio (such as ambient sounds) at a specific requested location. The audio is captured and sourced from existing user equipments at the specified location thereby avoiding any need for dedicated audio sensors or any specific deployment of such audio sensors.

It will be appreciated that the approach can be used to generate many new and exciting services. For example, users may request a real time audio stream to be provided from a location where a major sports event is currently taking place thereby allowing an automatic real time audio stream from within the stadium to be provided from user equipments of spectators within the stadium.

In particular, the approach may allow real time and/or real world audio data to be introduced or included in user experiences based on virtual models or worlds. For example, a virtual experience wherein a user is moving within a virtual representation of a real world location can be provided with real time and real world audio from the actual location. For example, a virtual tourist moving across a virtual representation of Trafalgar Square in London can be provided with real time audio from the real world Trafalgar Square merely by the virtual tourist application requesting real time audio for the real world location of Trafalgar Square.

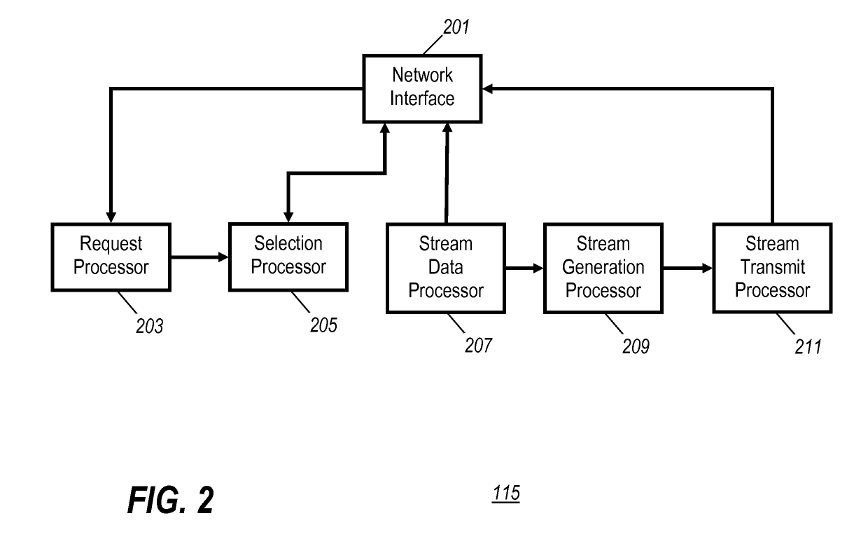

FIG. 2 illustrates an example of an audio stream server 115 in accordance with some embodiments of the invention.

The audio stream server 115 comprises a network interface 201 which in the example interfaces the audio stream server 115 to the central network 113. It will be appreciated that in other embodiments, the network interface 201 may provide an interface to other communication means and in particular may provide an interface to the Internet which may be used to communicate with the requesting unit and/or the stream feed units for the audio stream.

The network interface 201 is coupled to a request processor 203 which is arranged to receive audiovisual stream requests from communication units (which in the example corresponds to user equipments of the cellular communication system).

The operation of the audio stream server 115 will be described with reference to a specific example wherein the first communication unit 101 requests a real-time audio stream to be provided.

In the example, the first user equipment 101 is coupled to a computer (not shown) which operates a virtual tourist application wherein a user may move around in a virtual model of a geographical area such as a virtual model of a real city. For example, the application may model the city of London allowing users in other locations including other countries or continents to experience a virtual visit to the city of London. Furthermore, the virtual application can at intervals (for example periodically or when a specific predetermined location is entered) request a real-time and real world audio stream from the real location corresponding to the user's current virtual location. The application can specifically generate a real-time audio stream request which furthermore comprises an indication of the location for which the audio stream is required.

This request message can then be transmitted to the audio stream server 115 via the first user equipment 101.

Thus, the request processor 203 receives the audio stream request from the first user equipment 101 and extracts the location indication. It will be appreciated that any suitable means of indicating a location can be used such as e.g. a specific location coordinate, a place name, a nearby reference point etc.

The request processor 203 is coupled to a selection processor 205 which then proceeds to select a group of stream feed units from a plurality of stream feed units in response to the location indication. In the example, the stream feed units are user equipments 103 of the cellular communication system which are used as sources of the audio stream. Accordingly, the selection processor 205 proceeds to identify a set of user equipments 103 which meet a suitable location criteria. As a simple example, the selection processor 205 can select the group of stream feed units as the group of user equipments 103 that are within a given distance (say within 100 m) of the location indicated in the request message.

The selection processor 205 can then transmit an audiovisual stream request to the selected user equipments 103 (or user equipment in case the group only comprises a single user equipment). Each user equipment 103 can in response to receiving this request select to comply with the request or to reject it. If the user equipment 103 complies with the request, it starts capturing the audio environment and to transmit audio stream data representing this audio to the audio stream server 115.

Thus, once one or more candidate stream feed units (user equipments) have been identified, the audio stream server 115 can send these units a message requesting them to start streaming the local ambient sound captured at their location. In some embodiments, the streaming will begin only if the user has manually agreed to start this thereby preventing any infringement of the user's privacy.

For example, a number of mobile phones may be requested to provide an audio stream and may in response set up a communication link to the audio stream server 115 after which they can proceed to transmit audio data reflecting the sound captured by the microphone of the mobile phones. Thus, the audio stream server 115 will receive one or more audio streams reflecting the audio environment (e.g. ambient noise) at the location indicated by the virtual application.

The communication between the feed user equipments 103 and the audio stream server 115 can specifically be a one-way communication from the feed user equipment 103 to the audio stream server 115. Thus, the individual feed user equipment 103 is not involved in an active two-way communication but rather performs a passive capturing and transmission of audio data to provide a continuous audio stream. Thus, the user of the feed user equipments 103 need not be involved or perform any activity.

Specifically, the only audiovisual data communicated between the feed user equipment 103 and the audio stream server 115 may be communicated from the feed user equipment 103 to the audio stream server 115. Indeed, the feed user equipments 103 may not receive any user data or audiovisual data from the audio stream server 115 or possibly from any source. Thus, during a stream operation the feed user equipments 103 may simply provide a continuous one-way streaming of real-time ambient audio from the location of the user equipment 103. It will be appreciated, that a two-way control data communication may be maintained between the user equipment 103 and the audio stream server 115 to support the streaming. Such control data communication can for example be used to control the characteristics of the audio stream, such as the data rate of the audio data.

It will be appreciated, that any suitable communication service can be used to communicate the audio streaming data from the feed user equipments 103 to the audio stream server 115. For example, a conventional speech communication link can be set up between the entities and/or e.g. a one-way or asymmetric data communication can be used, including e.g. data packet services. As another example, the audio streaming data may be provided via the Internet.

The audio stream server 115 comprises a stream data processor 207 which is coupled to the network interface 201. The stream data processor 207 receives the audio streaming data from one or more feed user equipments 103 that have decided to comply with the request. Thus, the stream data processor 207 receives audiovisual streams, which in the specific case comprises streaming audio data, from at least one stream feed unit of the selected group of stream feed units (which in the specific case is a selected group of user equipments 103 of the cellular communication system).

The received audio streaming data is fed to a stream generation processor 209 which proceeds to generate a single audio stream for the first user equipment 101.

As a simple example, the stream generation processor 209 can simply select one audio stream of the received audio streams, such as e.g. the audio stream which has the lowest signal to noise ratio (in accordance with any suitable signal-to-noise estimation algorithm). As an even simpler the stream generation processor 209 can simply select the audio stream from the feed user equipment 103 that is closest to the desired location.

The stream generation processor 209 is coupled to a stream transmit processor 211 which is further coupled to the network interface 201. The stream transmit processor 211 receives the generated audio stream data from the stream generation processor 209 and transmits this to the first user equipment 101. The first user equipment 101 then forwards the received audio data to the virtual tourist application which outputs the real-time audio from the real world location corresponding to the current location of the user in the virtual world.

Thus, the system may allow an improved user experience and may in particular allow an enhancement of a virtual world experience by providing a closer correlation and interaction with the real world. Furthermore, this may be achieved by exploiting already existing equipment and in particular by exploiting a cellular communication system which typically provides almost ubiquitous coverage thereby allowing audio streams to be provided from a wide range of locations. In particular, real live audio streams will typically be of most interest for locations wherein there is a high probability that user equipments will be present. For example, a live audio stream will almost always be available from major tourist attractions such as Trafalgar Square as the real Trafalgar Square will almost always be populated by users having cellular mobile phones that can provide the desired stream.

The selection of the group of candidate feed user equipments 103 may take into account a number of different requirements.

Firstly, different requirements may be used to select user equipments 103 that are considered to be sufficiently close to the indicated location. Thus, only user equipments 103 that are at a location which meets a criterion relative to the location indication will be included in the group. The location of the user equipments 103 is estimated using any suitable algorithm or approach including for example using a GPS receiver located at the individual user equipment 103, using a network based triangulation location estimation and/or using a user equipment based triangulation location estimation as will be well known to the person skilled in the art.

As a simple example the location criterion may simply require that only user equipments 103 which are within a given distance of the indicated location can be included in the candidate group.

In addition to a location based requirement, the candidate group may furthermore reflect other requirements.

For example, it may be required that the user equipments 103 are in a specific mode of operation. In particular, only user equipments 103 which are currently in an idle mode of operation may be included in the candidate set thereby limiting the possible feed user equipments 103 to those user equipments 103 that are not active in any other user data communication. Thus, the system may ensure that no detrimental impact is introduced to any ongoing communications e.g. due to resource limitations (such as limited computational resource) at the individual device. This may also further facilitate operation as a limitation to idle mode user equipments reduces the probability of the audio stream comprising a strong component relating to a voice communication of a user of the individual user equipment.

It will be appreciated that the candidate group may also be generated with other requirements in mind. For example, the individual user equipment 103 may by the user be configured for a mode wherein it will not take part in an audio stream process. E.g., the user may enter the user equipment 103 into a “Meeting” or “Private” mode of operation wherein it will not take part in any audio streaming.

As another example the selection processor 205 may keep track of which user equipments 103 are involved in providing streaming and may avoid that the same user equipments 103 are used too frequently. The audio stream server 115 may e.g. also use load balancing algorithms to request streaming only from a subset of candidate user equipments 103 which meet the criteria. Also, the audio stream server 115 may dynamically change the set of active stream user equipments 103 during a streaming session (or between sessions).

As another example, the candidate group may further be restricted to include only user equipments 103 of a specific type or manufacturer. For example, some mobile phones may have microphones which are not suitable for capturing ambient sound (e.g. because they are optimised for close proximity speech audio) whereas other mobile phones may be suitable for capturing ambient sound (e.g. because they comprise speakerphone functionality including a microphone set up for a wide range audio capture). In this case, the candidate group may e.g. only include user equipments of the latter type.

It will also be appreciated, that in some embodiments some or all of these requirements may be considered by the individual user equipment 103 when receiving the request to provide audio streaming.

For example, when receiving an audio streaming request, the candidate user equipment 103 may determine whether it is ready or not to stream local ambient sound. For example, the candidate user equipment 103 may typically not accept the streaming request if:
It is currently used for performing voice communication;
Its current status is inconvenient for capturing ambient sound (e.g. it is a ‘Meeting’ or ‘Private’ mode);
Its geographical location is inconvenient for capturing ambient sound (e.g. in an office);
The user does not want to participate in the service, and has configured his device accordingly.
In some embodiments, the selection processor 205 itself performs the entire selection and evaluates all criteria and requirements. For example, the selection processor 205 may continuously be provided with location estimates for a number of user equipments 103 and may in response to the request identify the user equipments for which the location estimate is sufficiently close to the indicated location in the request.

However, in the specific example, the selection processor 205 is arranged to interwork with other functionality of the cellular communication system in order to select the candidate group.

Specifically, when the audio stream request is received from the first user equipment 101, the selection processor 205 can in response transmit a stream feed unit request to a remote server. The remote server can specifically be a server of the cellular communication system which comprises or has access to location information for the user equipments 103 of the cellular communication system.

The stream feed unit request comprises an indication of the location indicated in the request message from the first user equipment 101 and the remote server can then proceed to identify user equipments 103 which e.g. meet a location criteria relative to this indication. The remote server can then generate an indication of a subset of user equipments 103 which meets this criterion and transmit this indication back to the selection processor 205 via the network interface 201. Specifically, the remote server can identify the user equipments 103 which are currently sufficiently close to the indicated location and indicate these to the selection processor 205.

Thus, the audio stream server 115 can specifically contact one or more cellular operators (with which a commercial agreement to support the service has been established) and provide them with the target coordinates. The operators can then from their location servers generate a list of the user equipments 103 that may be located in the desired area. The list is then transmitted from the respective operators to the audio stream server 115.

The selection processor 205 may in some embodiments simply select the candidate group as the subset of user equipments 103 identified by the remote server of the cellular communication system. However, in other embodiments the subset may be further refined by the selection processor 205. For example, the selection process 205 can evaluate further requirements, such as a requirement that the user equipments 103 are of a specific type or from a specific manufacturer.

As another example, the selection processor 205 may initiate a communication with the user equipments 103 of the subset in order to obtain further information that can be used to refine the candidate group.

As an example, the selection processor 205 may transmit a location request message to the user equipments 103 of the subset.

In response to receiving this request, the user equipments 103 may transmit a location indication back to the selection processor 205. This location indication may be based on a location estimate generated in the user equipment 103 itself and may accordingly typically be significantly more accurate than the location estimate available within the cellular network. For example, many user equipments 103 may comprise a built-in GPS receiver which generates location estimates with a very high degree of accuracy.

After receiving the location indications from the user equipments 103, the selection processor 205 can proceed to select user equipments 103 for the candidate group using a much stricter distance requirement than was used to initially determine the subset.

For example, the cellular communication system may provide a list of user equipments 103 which are considered to be within, say, a 500 m radius of the desired location reflecting the uncertainty of location estimates available to the cellular network. The selection processor 205 may then contact the identified user equipments 103 to obtain very accurate location estimates. It may then proceed to generate the candidate group as the user equipments 103 which are within, say, a 50 m radius of the desired location.

In some cases, the selection processor 205 may also further check whether the user equipments 103 of the subset are ready to transmit real-time audio content. This may be achieved using a second interrogation step or may be combined with the request for location indications.

In the above example, the audio stream for the requesting user equipment 101 was generated by selecting one of the received audio streams from the feed user equipments 103. However, in many embodiments a more complex processing will be performed by the stream generation processor 209.

Specifically, the stream generation processor 209 may generate the audio stream for the first user equipment 101 by combining audio data received from a plurality of feed user equipments 103. Thus, audio data streams from active stream user equipments 103 (i.e. user equipments 103 which provide audio data to the audio stream server 115) may be combined.

The combination may for example include some form of averaging of the incoming audio data. For example, the audio signals from the feed user equipments 103 may be combined by a weighted summation. The weights for each individual stream may for example be identical corresponding to a simple averaging of all signals. As another example, predetermined or dynamically determined weights may be used e.g. to prioritise one signal relative to other signals. For example, the closer the user equipment 103 is to the desired location, the higher the weighting may be in the summation.

The application of an averaging function may provide a number of advantages. In particular it may allow a signal to be generated which more accurately represents the ambient audio in the given location as the effect of sound sources close to an individual user equipment 103 can be reduced. The averaging may for example allow the generated audio stream for the first user group 101 to reflect the audio which is common for the different user equipments 103 and to attenuate signals which are different for the different user equipments 103. This may for example allow speech from a user of a specific user equipment 103 to be attenuated in the generated audio stream for the first user equipment 101.

It will be appreciated that other approaches may be used to reduce speech components in the generated audio stream thereby providing an audio stream increasingly representing the ambient audio at the location. It will be appreciated that complex speech removal algorithms may be used, such as e.g. an algorithm based on performing a speech encoding and synthesis to generate a speech signal which can then be subtracted from the audio stream.

As another example, the stream generation processor 209 may comprise a filter that attenuate frequencies in the frequency range of speech.

The removal or attenuation of speech components not only provides an improved ambient audio stream but is also suitable for attenuating or removing user associated information in the provided audio stream.

It will also be appreciated that filtering may be used to remove undesired audio components and specifically may be used to attenuate noise. For example, high pass or low pass filtering may be used to remove high or low frequencies which often contribute substantially to the perceived noise of the signal. As another example, an adaptive filter may be applied to each received audio stream to remove wind noise components.

In some embodiments, the stream generation processor 209 may additionally or alternatively be arranged to synchronise audio data received from a plurality of feed user equipments 103 active in providing an audio stream.

Specifically, as the audio signals are captured at different locations by the individual user equipment 103 a varying delay may be introduced to the different audio streams. Furthermore, a varying delay may be introduced by the communication from the feed user equipments 103 to the audio stream server 115. The stream generation processor 209 may then synchronise the received audio streams by adjusting variable delays for the individual audio streams so that these are aligned with each other. The stream generation processor 209 may for example determine the required delay by detecting significant or characteristic events in the audio stream and comparing their relative timing in each audio stream.

In some embodiments, the feed user equipments 103 may provide dynamic location estimates to the audio stream server 115 when they are involved in providing an audio stream. For example, each user equipment 103 may comprise a GPS receiver and may at periodic intervals transmit the current location estimate provided by the GPS receiver to the audio feed server 115. The location estimate may be transmitted together with the audio stream or may be transmitted independently of this. As another example, the audio stream server 115 may at regular intervals request a location estimate from the feed user equipments 103 and these may in respond transmit the current location estimate to the audio stream server 115.

The audio stream server 115 may then proceed to compare this location estimate to a given criterion which is based on the desired location indicated by the first user equipment 101. The audio stream server 115 can proceed to exclude the audio stream from any user equipment 103 for which the location estimate meets the criterion. This may allow a continuous adaptation and refinement of the generated audio stream provided to the first user equipment 101 and may specifically ensure that this continues to be related to the desired location.

The evaluated criterion can specifically include a requirement that the location estimate is more than a given distance from the desired location. Thus, the criterion applied to an active feed user equipment 103 in order to determine whether it should be excluded may be the opposite of the criterion that is used to determine whether it should be included in the first place. Thus, the audio stream server 115 can detect if a user equipment 103 currently involved in generating the audio stream moves too far away from the desired location. If so, the audio stream from this user equipment 103 will be discarded.

It will be appreciated that the distance required to add a user equipment 103 to the active set of user equipments 103 may be different from the criterion that is used to exclude an active user equipment 103 from the set. For example, in order to include a user equipment 103 it may be required that it is within 25 m of the desired location whereas user equipments are only removed from the active said if they move to be more than 50 m away from the desired location.

In some embodiments, dynamic location estimates may also be received from user equipment 103 that are currently not active in generating the audio stream for the first user equipment 101. For example, user equipments 103 may at regular intervals transmit a new location estimate directly to the audio stream server 115.

As previously described, the selection processor 205 may store these location estimates and use them to identify the candidate group of user equipments 103 when a new audio streaming request is received from a user equipment 101. Alternatively or additionally, the audio stream server 115 can compare such estimates to location criteria for currently active streaming processes in order to decide whether any user equipments should be added to the current streaming process. For example, if a location estimate is received that indicates that the corresponding user equipment 103 has moved to be within the required distance from the specified location for the current audio streaming service, this user equipment 103 may be added to the set of active feed user equipments 103.

It will be appreciated, that although the previous description focuses on an example wherein an audio streaming process is provided, the described principles are equally applicable to other forms of audiovisual signals including combined audio and video signals as well as video only signals or audiovisual signals comprising a single image. For example, for video signals the request received from the audio stream server 115 may also be used by the user equipments 103 to actively generate a request to the users to hold the user equipment 103 in a position wherein a suitable video signal can be generated.

In order for the described system to perform optimally, an active involvement of users is desired. For example, the system is most likely to provide the best audio streaming if a large number of users are prepared to allow their user equipments/mobile phones to provide an audio stream. In order to stimulate this involvement, an incentive for participation may be provided by the system.

It will be appreciated that many different incentive systems and models are known and can be used. For example, a simple incentive scheme would consist in providing a minor monetary reward for allowing a user equipment to be used for audio streaming. As another example, a user's access to an audio streaming service may be made dependent on the user's own participation in providing audio streams.

In some embodiments, the audio stream received from the stream user equipments 103 may be cached by the audio stream server 115 in order to be re-played subsequently. In such cases, the requesting user may be notified that he is not provided with real-time sound.

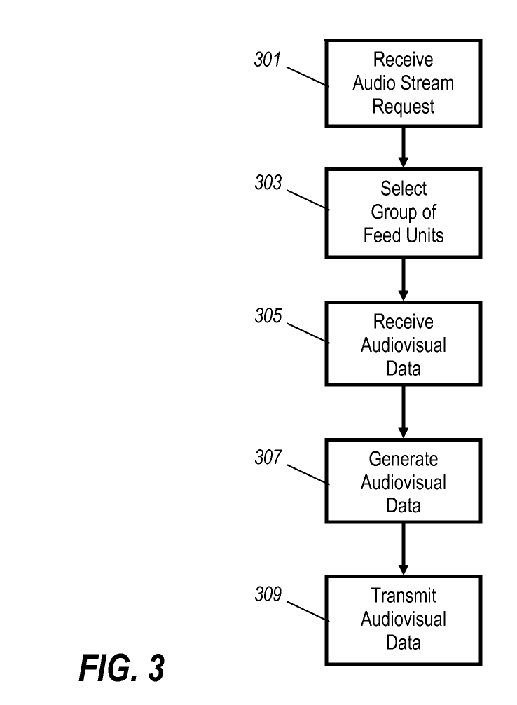

FIG. 3 illustrates a method of providing an audiovisual stream in accordance with some embodiments of the invention.

The method starts in step 301 wherein an audiovisual stream request is received for an audiovisual stream from a communication unit. The audiovisual stream request comprises a location indication for the audiovisual stream.

Step 301 is followed by step 303 wherein a group of stream feed units is selected from a plurality of stream feed units in response to the location indication.

Step 303 is followed by step 305 wherein received audiovisual stream is received from at least one stream feed unit of the group of stream feed units.

Step 305 is followed by step 307 wherein first audiovisual stream is generated for the communication unit from the received audiovisual stream(s).

Step 307 is followed by step 309 wherein the first audiovisual stream is transmitted to the communication unit.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus comprising
means for receiving an audiovisual stream request for an audiovisual stream from a communication unit, the audiovisual stream request comprising a location indication for the audiovisual stream;
selection means for selecting a group of stream feed units from a plurality of stream feed units in response to the location indication;
means for receiving at least one received audiovisual stream from at least one stream feed unit of the group of stream feed units;
generation means for generating a first audiovisual stream for the communication unit from the at least one received audiovisual stream; and
means for transmitting the first audiovisual stream to the communication unit.

2. The apparatus of claim 1 wherein the stream feed units are user equipments of a cellular communication system.

3. The apparatus of claim 2 wherein the group of stream feed units comprise user equipments in an idle mode of operation.

4. The apparatus of claim 2 wherein the group of stream feed units comprise user equipments not receiving any user data.

5. The apparatus of claim 1 wherein the group of stream feed units comprises only stream feed units having an associated location estimate meeting a criterion relative to the location indication.

6. The apparatus of claim 1 wherein the group of stream feed units comprises only stream feed units in an operating mode meeting a criterion.

7. The apparatus of claim 1 wherein the group of stream feed units comprises only stream feed units having a characteristics meeting a criterion.

8. The apparatus of claim 1 wherein the selection means is arranged to:
transmit a stream feed unit request to a remote server in response to receiving the audiovisual stream request, the stream feed unit request comprising the location indication;
receive an indication of a subset of stream feed units of the plurality of stream feed units meeting a criterion relative to the location indication; and
selecting the group of stream feed units from the subset of stream feed units.

9. The apparatus of claim 8 wherein the subset of stream feed units comprises user equipments of a cellular communication system and the remote server is a server of a cellular communication system.

10. The apparatus of claim 8 further comprising means for transmitting a location request to stream feed units of the subset of stream feed units;
means for receiving location indications from at least some of the subset of stream feed units; and
wherein the selection means is arranged to select the group of stream feed units in response to the location indications.
